(19) United States
(12) Patent Application Publication
(10) Pub. No.: US 2024/0286604 A1
(43) Pub. Date: Aug. 29, 2024

(54) METHOD OF CONTROLLING COLLISION AVOIDANCE OF VEHICLE

(71) Applicants: HYUNDAI MOTOR COMPANY, Seoul (KR); KIA CORPORATION, Seoul (KR)

(72) Inventors: Myung Ki Yeom, Incheon (KR); In Su Kim, Anyang-si (KR)

(73) Assignees: HYUNDAI MOTOR COMPANY, Seoul (KR); KIA CORPORATION, Seoul (KR)

(21) Appl. No.: 18/230,823

(22) Filed: Aug. 7, 2023

(30) Foreign Application Priority Data
Feb. 24, 2023 (KR) 10-2023-0024702

(51) Int. Cl. B60W 30/09; B60W 30/095; B60W 60/00

(52) U.S. Cl. CPC B60W 30/09; B60W 30/0956; B60W 60/001; B60W 2510/244; B60W 2554/4041; B60W 2554/80

(57) ABSTRACT

A method of controlling collision avoidance of a vehicle, which is capable of preventing a collision accident caused by other vehicle even in a parked or stopped state of the vehicle, includes: detecting other vehicle in the parked or stopped state of the vehicle and predicting whether a collision occurs due to a movement of other vehicle and turning the vehicle during parking or stopping in a collision avoidance direction using a driving torque and a braking torque when a collision is expected due to the movement of other vehicle.

### CROSS-REFERENCE TO RELATED APPLICATION

The present application claims priority to Korean Patent Application No. 10-2023-0024702 filed on Feb. 24, 2023, the entire contents of which is incorporated herein for all purposes by this reference.

### BACKGROUND OF THE PRESENT DISCLOSURE

### Field of the Present Disclosure

The present disclosure relates to a method of controlling collision avoidance of a vehicle, and more particularly, to a method of controlling collision avoidance of a vehicle by turning a vehicle to avoid a collision during parking or stopping when a collision due to a movement of other vehicle is expected.

### DESCRIPTION OF RELATED ART

A driving mode of an autonomous vehicle includes a manual driving mode in which a driver can directly intervene in driving, in addition to an autonomous driving mode for traveling to a destination by itself without the driver directly manipulating a steering wheel, an accelerator pedal, and a brake pedal.

Therefore, according to an intent of the driver for selecting a driving mode, the driving mode of the autonomous vehicle may be selected as an autonomous driving mode under the control of an autonomous driving controller or a manual driving mode in which the driver can directly perform a driving operation.

When the autonomous vehicle is traveling in the autonomous driving mode, and even when the autonomous vehicle faces various risks of collision accidents such as the presence of a preceding obstacle, other vehicle in an adjacent lane suddenly cutting in, or sudden braking of a preceding vehicle, driving control for avoiding a collision with other vehicle may be performed by the autonomous driving controller.

However, when other vehicle approaches and collides with the vehicle in a parked or stopped state not during traveling, the vehicle inevitably suffers from a collision accident.

For example, although the autonomous vehicle is capable of performing collision avoidance control during traveling, because control for predicting or avoiding a collision with other vehicle is not performed in the parked or stopped state, a collision accident may inevitably occur due to a movement of other vehicle.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method of controlling collision avoidance of a vehicle, which is configured for preventing a collision accident caused by a movement of other vehicle even in a parked or stopped state of the vehicle by detecting other vehicle in the parked or stopped state of the vehicle and predicting whether a collision occurs due to the movement of other vehicle and turning the vehicle during parking or stopping in a collision avoidance direction using a driving torque and a braking torque when a collision is expected due to the movement of other vehicle.

Objectives of the present disclosure are not limited to the above-described objectives, and other objectives of the present disclosure, which are not mentioned, may be understood by the following description and also will be apparently understood through embodiments of the present disclosure. Furthermore, the objectives of the present disclosure may be implemented by means described in the appended claims and a combination thereof.

In an exemplary embodiment of the present disclosure, the present disclosure provides a method of controlling collision avoidance of a vehicle, which includes monitoring, by an detection portion for autonomous driving of the vehicle, information on other vehicle, which is approachable to the vehicle, and an object in a parked or stopped state after a starting of the vehicle is turned off: determining, by an autonomous driving controller, whether the other vehicle moves based on the monitored information of the detection portion for the autonomous driving: when the autonomous driving controller concludes that the other vehicle moves, determining, by the autonomous driving controller, a collision index representing a probability of collision of the other vehicle with the vehicle; and comparing the collision index with a reference value, and when the collision index is greater than the reference value, controlling, by the autonomous driving controller, the vehicle in a direction of the collision avoidance with the other vehicle.

The method of controlling collision avoidance of a vehicle according to an exemplary embodiment of the present disclosure may further include, before the starting of the vehicle is turned off, checking, by the detection portion for the autonomous driving, the information on the other vehicles and the object present around the vehicle.

The method of controlling collision avoidance of a vehicle according to an exemplary embodiment of the present disclosure may further include, before the starting of the vehicle is turned off, determining, by the autonomous driving controller, whether accident prevention control of the vehicle during parking or stopping is activated.

When the activation of the accident prevention control during the parking or the stopping is selected through an operating switch, a cluster for audio, video, navigation (AVN), or one input device among a display, a voice input device, and a smart device, the autonomous driving controller may be configured to determine that the activation of the accident prevention control during the parking or the stopping is performed.

When the detection portion for the autonomous driving monitors the information on the other vehicle, which is approachable to the vehicle, and the object, the monitoring may be performed at a low speed sampling for preventing battery discharging of the vehicle.

The method of controlling collision avoidance of a vehicle according to an exemplary embodiment of the present disclosure may further include, when the detection portion for the autonomous driving monitors the information on the other vehicle, which is approachable to the vehicle, and the object, notifying a driver when a state of charge (SOC) of a battery is less than a reference value and terminating the accident prevention control during parking or stopping to prevent battery discharging.

In the determining, by the autonomous driving controller, whether the other vehicle moves, when the autonomous driving controller concludes that the movement of the other vehicle approachable to the vehicle is detected, the detection portion for the autonomous driving may monitor the movement of the other vehicle at a high speed sampling.

The collision index may be determined by multiplying a vehicle speed of the other vehicle approaching the vehicle, a distance between the vehicle and the other vehicle, and a predicted area of collision of the other vehicle with the vehicle.

The method of controlling collision avoidance of a vehicle according to an exemplary embodiment of the present disclosure may further include differently determining the predicted area of collision based on a vehicle body length, a vehicle body width, a vehicle body height, and a distance from the frontmost portion of the vehicle body to the center of gravity among vehicle specifications, a distance from the center of gravity of the vehicle to the other vehicle, and a relative heading angle of the vehicle with the other vehicle.

To the present end, the determining of the predicted area of collision may include setting, by the autonomous driving controller, a vehicle body in a quadrangular shape based on the center of gravity based on the vehicle body length, the vehicle body width, the vehicle body height, and the distance from the frontmost portion of the vehicle body to the center of gravity: determining, by the autonomous driving controller, the distance from the center of gravity of the vehicle to the other vehicle and the relative heading angle with the other vehicle: when the distance from the center of gravity of the vehicle to the other vehicle is within a predetermined distance, projecting, by the autonomous driving controller, the other vehicle onto the vehicle in a direction of the relative heading angle; and superimposing the projected other vehicle with the vehicle body set in the quadrangular shape and determining a cross-sectional area of a superimposed portion as the predicted area of collision.

The comparing of the collision index with the reference value may include comparing a highest maximum collision index among collision indexes of other vehicles with a first reference value, and comparing the highest maximum collision index among the collision indexes of the other vehicles with a second reference value.

Thus, when the maximum collision index is greater than the first reference value, power may be applied in advance to control portions and actuating portions of the vehicle for turning the vehicle in the direction of collision avoidance with the other vehicle.

Furthermore, when the maximum collision index is greater than the second reference value, the controlling, by the autonomous driving controller, of the vehicle in the direction of collision avoidance with the other vehicle may be performed.

The controlling, by the autonomous driving controller, of the vehicle in the direction of collision avoidance with the other vehicle may include determining the direction of collision avoidance of the vehicle, determining a rotation center of the vehicle for turning the vehicle in the direction of collision avoidance, determining a target rotation angle of the vehicle, determining a steering angle of the vehicle, selecting a driving wheel and a braking wheel among wheels of the vehicle and determining a forward or backward driving direction of the selected driving wheel, and applying a braking torque to the braking wheel and applying a driving torque to the driving wheel.

The rotation center of the vehicle may be determined as the center of gravity of the vehicle or one selected among the wheels of the vehicle according to a heading angle and a position of the other vehicle with respect to a heading angle and a position of the vehicle, and the predicted area of collision of the other vehicle with respect to the vehicle.

The target rotation angle of the vehicle may be determined as an angle at which the vehicle may be rotated to a position which is the position as away from other vehicle as possible and where the vehicle is disposed parallel to or perpendicular to the other vehicle according to the heading angle and the position of other vehicle with respect to the heading angle and the position of the vehicle, and the predicted area of collision of the other vehicle with respect to the vehicle.

The steering angle of the vehicle may be determined as a maximum steering angle to rapidly turn the vehicle in the direction of collision avoidance.

Furthermore, the controlling, by the autonomous driving controller, of the vehicle in the direction of collision avoidance with the other vehicle may further include controlling the vehicle to be stopped at the target rotation angle after the vehicle is rotated only to the target rotation angle for collision avoidance.

The controlling of the vehicle to be stopped at the target rotation angle may include setting in advance a braking start time point t1 at which braking of the vehicle starts in advance before reaching the target rotation angle, a driving torque end time point t2 at which the driving torque becomes zero before reaching the target rotation angle, a maximum braking torque application time point t3 at which a maximum braking torque is applied to stop the vehicle when the vehicle reaches the target rotation angle, and a target rotation angle reaching time point t4 at which the vehicle is stopped at the target rotation angle: when the vehicle is rotated in the direction of collision avoidance to reach the braking start time point t1, primarily applying the braking torque to each wheel of the vehicle in advance: when the vehicle is rotated in the direction of collision avoidance to reach the driving torque end time point t2, controlling the driving torque applied to the driving wheel to zero; and when the vehicle is rotated in the direction of collision avoidance to reach the maximum braking torque application time point t3, applying the maximum braking torque to all the wheels until the target rotation angle reaching time point t4.

The method of controlling collision avoidance of a vehicle according to an exemplary embodiment of the present disclosure may further include notifying the termination of the accident prevention control of the vehicle during parking or stopping and a driver notification operation of asking whether to keep the vehicle rotated in the direction of collision avoidance or whether to rotate the vehicle to return to an original parking position of the vehicle.

Other aspects and exemplary embodiments of the present disclosure are discussed infra.

It is understood that the term “vehicle” or “vehicular” or other similar term as used herein is inclusive of motor vehicles in general such as passenger vehicles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

The above and other features of the present disclosure are discussed infra.

### BRIEF DESCRIPTION OF THE DRAWINGS

FIG. 1 and FIG. 2 are control configuration diagrams for a method of controlling collision avoidance of a vehicle according to an exemplary embodiment of the present disclosure:

FIG. 3 and FIG. 4 are flowcharts illustrating the method of controlling collision avoidance of a vehicle according to an exemplary embodiment of the present disclosure;

FIG. 5 is a schematic diagram showing an example of monitoring, by an detection portion for autonomous driving of the vehicle, nearby other vehicles and objects in the method of controlling collision avoidance of a vehicle according to an exemplary embodiment of the present disclosure:

FIG. 6, FIG. 7, and FIG. 8 are schematic diagrams illustrating examples of setting a predicted collision area for determining a collision index in the method of controlling collision avoidance of a vehicle according to an exemplary embodiment of the present disclosure:

FIG. 9 is a schematic diagram illustrating an example of determining a collision avoidance direction of a vehicle in the method of controlling collision avoidance of a vehicle according to an exemplary embodiment of the present disclosure:

FIG. 10, FIG. 11, FIG. 12, FIG. 13 and FIG. 14 are schematic diagrams illustrating examples of determining a rotation center of a vehicle in the method of controlling collision avoidance of a vehicle according to an exemplary embodiment of the present disclosure:

FIG. 15 and FIG. 16 are schematic diagrams illustrating examples of determining a target rotation angle of a vehicle in the method of controlling collision avoidance of a vehicle according to an exemplary embodiment of the present disclosure:

FIG. 17 is a schematic diagram illustrating an example of determining a steering angle of a vehicle in the method of controlling collision avoidance of a vehicle according to an exemplary embodiment of the present disclosure:

FIG. 18 and FIG. 19 are schematic diagrams illustrating examples of determining driving wheels among wheels when the rotation center of the vehicle is determined as the center of gravity in the method of controlling collision avoidance of a vehicle according to an exemplary embodiment of the present disclosure:

FIG. 20 and FIG. 21 are schematic diagrams illustrating examples of determining a driving wheel, a non-driving wheel, and a braking wheel among the wheels when the rotation center of the vehicle is determined as a predetermined wheel in the method of controlling collision avoidance of a vehicle according to an exemplary embodiment of the present disclosure:

FIG. 22, FIG. 23, FIG. 24 and FIG. 25 are schematic diagrams illustrating examples in which a driving torque and a braking torque are selectively applied to each wheel of the vehicle to rotate the vehicle in a collision avoidance direction in the method of controlling collision avoidance of a vehicle according to an exemplary embodiment of the present disclosure:

FIG. 26 is a graph illustrating the rotation angle over time when the vehicle is rotated to the target rotation angle in the method of controlling collision avoidance of a vehicle according to an exemplary embodiment of the present disclosure; and

FIG. 27 is a graph illustrating an example of control for accurately stopping the vehicle at a target rotation angle in the method of controlling collision avoidance of a vehicle according to an exemplary embodiment of the present disclosure.

Other aspects and exemplary embodiments of the present disclosure are discussed infra.

It should be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings.

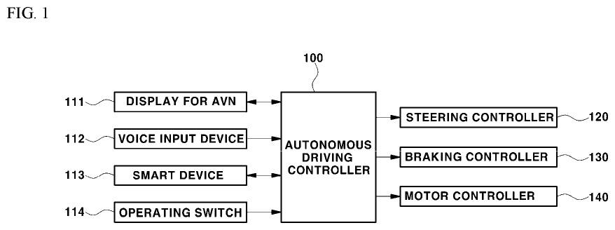

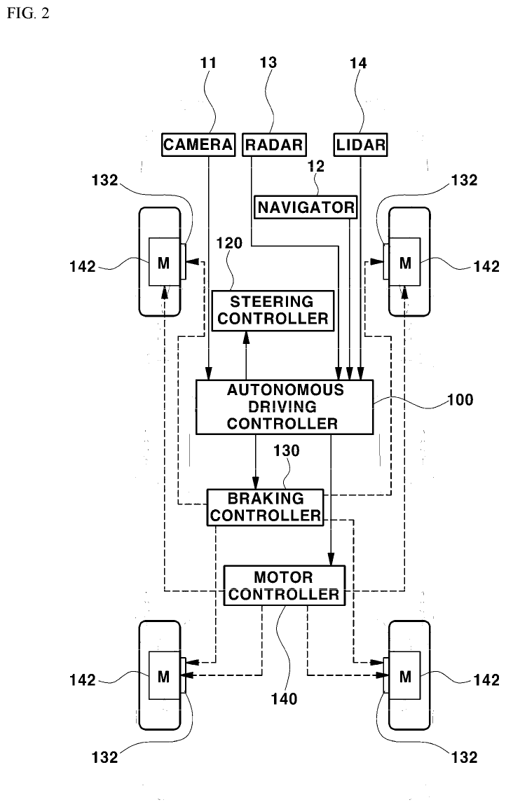

FIG. 1 and FIG. 2 are control configuration diagrams for a method of controlling collision avoidance of a vehicle according to an exemplary embodiment of the present disclosure.

As shown in FIG. 1, an autonomous driving controller 100 for overall autonomous driving control is provided in an autonomous vehicle, and a display 111, a voice input device 112, and a smart device 113, and an operating switch 114 for audio, video, navigation (AVN) are electrically connected to an input portion of the autonomous driving controller 100 to enable signal transmission and reception as input devices for selecting whether to activate accident prevention control during parking or stopping of the vehicle.

Furthermore, a steering controller 120 for steering control, a braking controller 130 for braking torque control, and a motor controller 140 for driving torque control are electrically connected to an output portion of the autonomous driving controller 100 to enable reception of command signals.

Thus, when a user selects activation of accident prevention control during parking or stopping among various menus displayed on the display 111 for AVN, which is one of the input devices, inputs the activation of the accident prevention control during parking or stopping through the voice input device 112, which is another one of the input devices, selects activation of the accident prevention control during parking or stopping through a dedicated app of the smart device 113, which is yet another one of the input devices, or inputs the activation of the accident prevention control during parking or stopping through the operating switch 114, which is yet another one of the input devices, the autonomous driving controller 100 may confirm a state in which the activation of the accident prevention control during parking or stopping is selected.

In the instant case, the accident prevention control during parking or stopping is referred to as a series of control which is configured for detecting other vehicle and predicting whether a collision due to a movement of other vehicle occurs when the vehicle is in a starting OFF state during parking or stopping and which is configured for turning the vehicle in a collision avoidance direction using a driving torque and a braking torque when the collision caused by the movement of other vehicle is expected.

As shown in FIG. 2, the autonomous driving controller 100 is configured to receive a variety of monitoring information required for autonomous driving from an detection portion for autonomous driving including a camera 11, a navigation 12, a radio detection and ranging (RADAR) 13, or a light imaging detection and ranging (LiDAR) 14, which is mounted in the vehicle and to perform overall autonomous driving control including a vehicle traveling direction and acceleration and deceleration control based on the monitoring information.

Furthermore, when the vehicle is in the starting OFF state during parking or stopping and when the accident prevention control of the vehicle during parking or stopping is activated, the autonomous driving controller 100 is configured to apply power for operation to the detection portion for the autonomous driving including the camera 11, the navigation 12, the RADAR 13, or the LiDAR 14. Thus, when the accident prevention control of the vehicle during parking or stopping is activated, the detection portion for the autonomous driving including the camera 11, the navigation 12, the RADAR 13, or the LiDAR 14 monitors other vehicle and a movement thereof.

Furthermore, when the accident prevention control of the vehicle during parking or stopping is activated, the autonomous driving controller 100 is configured to receive signals of detecting other vehicle and the movement thereof from the detection portion for the autonomous driving including the camera 11, the navigation 12, the RADAR 13, or the LiDAR 14, to determine a collision index indicating a probability of collision with other vehicle based on the received signals, and to predict a collision caused by the movement of other vehicle based on the determined collision index.

Furthermore, when the collision caused by the movement of other vehicle is expected based on the collision index, the autonomous driving controller 100 is configured to command a steering signal for collision avoidance with other vehicle to the steering controller 120 to allow the vehicle during parking or stopping to be turned in a collision avoidance direction, to command a braking torque signal for collision avoidance with other vehicle to the braking controller 130, and to command a driving torque signal for collision avoidance with other vehicle to the motor controller 140.

The steering controller 120 is configured to perform steering control according to a steering intent according to an autonomous driving logic of the autonomous driving controller 100 or a steering intent according to a steering wheel operation of the driver and to perform steering control for collision avoidance according to a steering signal command for collision avoidance with other vehicle.

The braking controller 130 is configured to perform control for selectively applying a braking torque for collision avoidance to a hydraulic braking system 132 mounted on each wheel according to the braking torque signal command for collision avoidance with other vehicle.

The braking controller 130 may be an integrated electric brake (IEB) controller including electronic stability control (ESC) for vehicle body attitude control.

The motor controller 140 is configured to perform driving torque control and regenerative braking torque control for driving with respect to an in-wheel motor (IWM) 142 mounted in each wheel of the vehicle and to perform control for selectively applying a driving torque for collision avoidance with respect to the IWM 142 mounted in each wheel according to the driving torque signal command for collision avoidance with other vehicle.

Therefore, the detection portion for the autonomous driving detects the movement of other vehicle during parking or stopping of the vehicle, the autonomous driving controller 100 is configured to determine the collision index and predicts whether the collision caused by the movement of other vehicle occurs based on the determined collision index. When the collision due to other vehicle is predicted, the detection portion for the autonomous driving selectively applies the driving torque and the braking torque to each wheel of the vehicle during parking or stopping to allow the vehicle during parking or stopping to be automatically turned in the collision avoidance direction, preventing a collision accident of the vehicle during parking or stopping.

Here, the method of controlling collision avoidance of a vehicle, which is performed based on the above configuration, will be described in detail below.

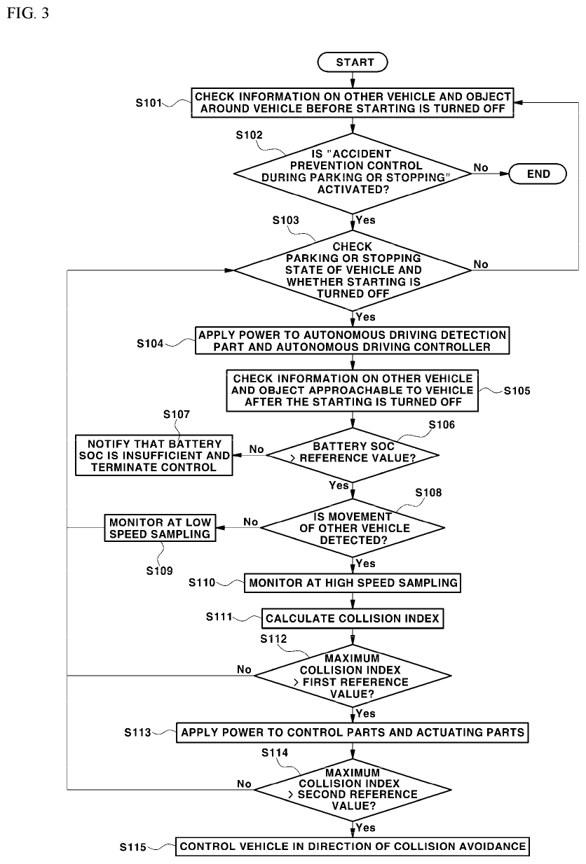

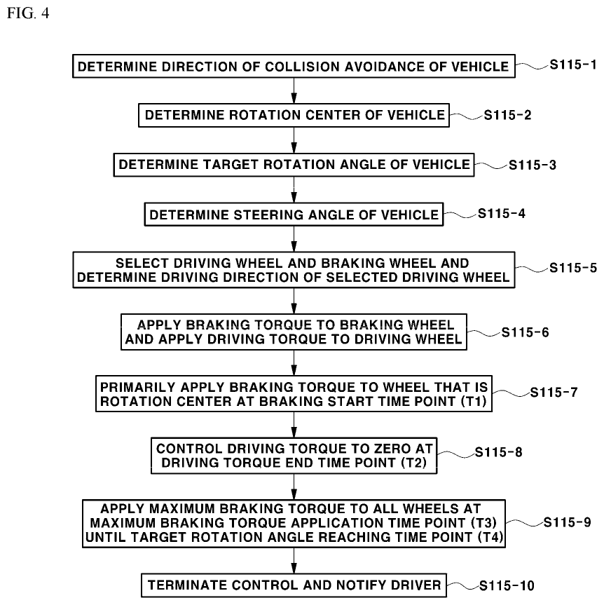

FIG. 3 and FIG. 4 are flowcharts illustrating the method of controlling collision avoidance of a vehicle according to an exemplary embodiment of the present disclosure.

First, before the starting of the vehicle is off, information on other vehicle and objects present around the vehicle is checked (S101).

For example, even when accident prevention control of the vehicle during parking or stopping is not activated before parking or stopping of the vehicle in a starting ON state, the detection portion for the autonomous driving including the camera 11, the RADAR 13, or the LiDAR 14 monitors information on other vehicle and objects present around the vehicle and transmits the monitored information to the autonomous driving controller 100.

In the instant case, the reason for monitoring the information on other vehicle and objects present around the vehicle in advance before the starting being off even when the accident prevention control of the vehicle during parking or stopping is not activated is that, when the accident prevention control of the vehicle during parking or stopping is activated in the starting OFF state, energy such as a battery for monitoring other vehicle is prevented from being discharged.

In other words, when the driver gets off the vehicle in the starting OFF state and remotely activates the accident prevention control during parking or stopping through a dedicated app of the smart device 113, discharging of energy such as a battery may occur according to the detection portion for the autonomous driving monitoring other vehicles present around vehicle. Thus, even when the accident prevention control during parking or stopping is not activated before the starting is turned off (a starting ON state in which energy such as a battery is not discharged), it is desirable to monitor the information on other vehicle and objects present around the vehicle in advance.

Subsequently, the autonomous driving controller 100 is configured to determine whether the accident prevention control of the vehicle during parking or stopping is activated (S102).

That is, the autonomous driving controller 100 checks whether the user selects activation of the accident prevention control of the vehicle during parking or stopping through the input device.

For example, when a user selects the activation of the accident prevention control during parking or stopping among various menus displayed on a cluster or the display 111 for AVN, which is one of the input devices, inputs the activation of the accident prevention control during parking or stopping through the voice input device 112, which is another one of the input devices, selects activation of the accident prevention control during parking or stopping through a dedicated app of the smart device 113, which is yet another one of the input devices, at a long distance, or inputs the activation of the accident prevention control during parking or stopping through the operating switch 114, which is yet another one of the input devices, the autonomous driving controller 100 may be configured to determine that the accident prevention control of the vehicle during parking or stopping is activated.

Accordingly, the autonomous driving controller 100 checks a parking or stopping state of the vehicle and whether the starting is turned off (S103).

For example, the autonomous driving controller 100 may check a state in which the vehicle is parked or stopped in a designated space such as a specific parking lot or shoulder based on vehicle position information provided from the navigation 12 and check the starting OFF state through an off signal of an ignition switch.

In the instant case, even when the starting of the vehicle is turned off, the autonomous driving controller 100 does not perform the actual accident prevention control during parking or stopping unless the vehicle is parked or stopped in a specific parking lot or a space such as a shoulder. This is because the driver may turn off the starting in a situation such as waiting for a traffic light during traveling on a road.

Next, when the starting is turned off in a state in which the vehicle is parked or stopped in a designated space, the autonomous driving controller 100 is configured to perform the actual accident prevention control during parking or stopping.

The actual accident prevention control during parking or stopping is referred to as a series of control which is configured for predicting whether a collision due to a movement of other vehicle occurs when the vehicle is in a starting OFF state during parking or stopping and which is configured for turning the vehicle in a collision avoidance direction using a driving torque and a braking torque when the collision caused by the movement of other vehicle is expected.

To the present end, first, when the starting is turned off in a state in which the vehicle is parked or stopped in a designated space, power is applied to the detection portion for the autonomous driving including the camera 11, the RADAR 13, or the LiDAR 14, and the autonomous driving controller 100 (S104).

Subsequently, information on other vehicle, which is approachable to the vehicle, and objects around the vehicle is checked in the starting OFF state (S105).

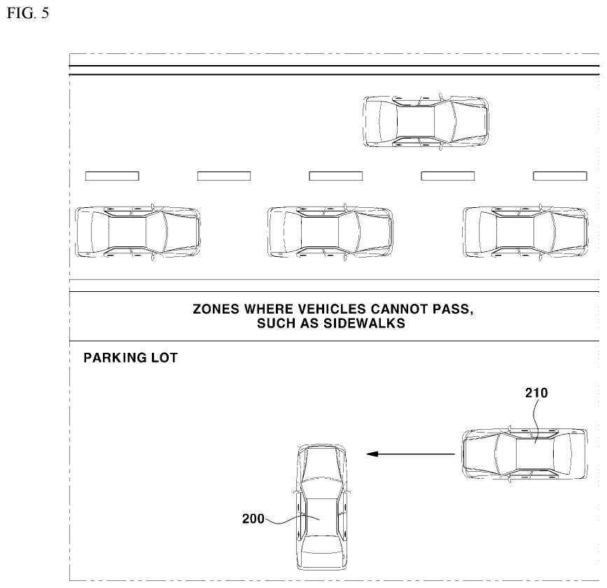

For example, referring to FIG. 5, the detection portion for the autonomous driving including the camera 11, the RADAR 13, or the LiDAR 14 monitors other vehicle 210 approachable to a vehicle 200 among other vehicles present around the vehicle 200, that is, the other vehicle 210 moved to the parked or stopped vehicle 200 and disposed in a state capable of collision contact and transmits the monitored information to the autonomous driving controller 100.

Furthermore, as shown in FIG. 5, the detection portion for the autonomous driving may monitor a sidewalk or a blocking curtain as object information and monitor other vehicles traveling on a road across the sidewalk or the blocking curtain. However, because the other vehicles traveling on a road across the sidewalk or the blocking curtain cannot approach the vehicle 200 due to the sidewalk or the blocking curtain, the other vehicles are excluded from other vehicles approachable to the vehicle 200.

Preferably, in S105, when the detection portion for the autonomous driving monitors the information on other vehicles and objects around the vehicle in the starting OFF state, to prevent battery discharging, the detection portion for the autonomous driving monitors the information on other vehicles and objects around the vehicle at low speed sampling (a time interval which is longer than a reference sampling time).

In the instant case, a state of charge (SOC) value of the battery is compared with a reference value (S106), and when the SOC value of the battery is less than the reference value, the accident prevention control during parking or stopping is terminated to prevent the battery discharging along with a notification notifying the driver that the SOC value of the battery is in an insufficient state (S107).

In other words, when the detection portion for the autonomous driving gradually consumes the SOC value of the battery in the starting OFF state and monitors the information on other vehicles and objects around the vehicle, and when the SOC value of the battery becomes to be less than the reference value after a certain time period, the autonomous driving controller 100 is configured to perform notification control for notifying the smart device 113 possessed by the driver that the SOC value of the battery is in an insufficient state and is configured to perform control for terminating the accident prevention control during parking or stopping to prevent the battery discharging.

Next, it is determined whether other vehicle is moved (S108).

For example, when the detection portion for the autonomous driving monitors the movement of other vehicle approachable to the vehicle and transmits the monitored information to the autonomous driving controller 100, the autonomous driving controller 100 may be configured to determine that the movement of other vehicle is detected.

As the determination result in S108, when it is determined that the movement of other vehicle approachable to the vehicle is detected, an operation of monitoring the movement of other vehicle at high speed sampling (a time interval which is shorter than the reference sampling time) is performed (S110).

For example, when the autonomous driving controller 100 determines that the movement of other vehicle approachable to the vehicle is detected, the autonomous driving controller 100 commands the detection portion for the autonomous driving to monitor the movement of other vehicle at high speed sampling (the time interval which is shorter than the reference sampling time), and thus the detection portion for the autonomous driving monitors the movement of other vehicle at high speed sampling and transmits the monitored information to the autonomous driving controller 100.

Otherwise, as the determination result in S108, when the movement of other vehicle is not detected or when the movement of other vehicle is not detected for a certain time period because other vehicle moves and then stops again, S103 starts as when the detection portion for the autonomous driving monitors the information on other vehicle and objects around the vehicle, and the detection portion for the autonomous driving monitors the information on other vehicle and objects around the vehicle at low speed sampling (the time interval which is longer than the reference sampling time) to prevent battery discharging (S109).

Next, when the autonomous driving controller 100 receives the information, in which the movement of other vehicle approaching the vehicle is monitored at high speed sampling, from the detection portion for the autonomous driving, the autonomous driving controller 100 is configured to determine a collision index representing a probability of collision between the vehicle and other vehicle based on the received information (S111).

In the instant case, the information provided from the detection portion for the autonomous driving to the autonomous driving controller 100 (information obtained by monitoring the movement of other vehicle approaching the vehicle at high speed sampling) may include a vehicle speed of other vehicle, a distance between the vehicle and other vehicle, and a heading angle and a position of other vehicle relative to a heading angle and a position of the vehicle.

Thus, as shown in the following Equation 1, the autonomous driving controller 100 may be configured to determine the collision index by multiplying the vehicle speed of other vehicle approaching the vehicle, the distance between the vehicle and other vehicle, and a predicted area of collision of the other vehicle with respect to the vehicle.

collision index=vehicle speed of other vehicle×distance between vehicle and other vehicle×predicted area of collision [Equation 1]

In Equation 1, the vehicle speed of other vehicle and the distance between the vehicle and other vehicle are values detected by the detection portion for the autonomous driving, and the predicted area of collision may be differently determined based on a vehicle body length, a vehicle body width, a vehicle body height, a distance from the frontmost portion of the vehicle body to the center of gravity CG thereof, a distance from the center of gravity CG of the vehicle to the other vehicle, and a relative heading angle with respect to other vehicle among vehicle specifications.

First, to determine the predicted area of collision, the autonomous driving controller 100 sets the vehicle body in a quadrangular shape based on the center of gravity CG based on the vehicle body length, the vehicle body width, the vehicle body height, and the distance from the frontmost portion of the vehicle body to the center of gravity CG thereof.

Subsequently, when the detection portion for the autonomous driving of the vehicle detects the movement of other vehicle and transmits the detected movement to the autonomous driving controller 100, the autonomous driving controller 100 of the vehicle identifies the distance from the center of gravity CG of the vehicle to the other vehicle and the relative heading angle with respect to other vehicle.

The relative heading angle with respect to other vehicle refers to an angle between a heading position of the vehicle and a heading position of other vehicle approaching the vehicle.

Next, when the distance from the center of gravity CG of the vehicle to the other vehicle is within a predetermined distance, the autonomous driving controller 100 projects other vehicle in a direction of the relative heading angle which is identified as described above.

Subsequently, the other vehicle projected in the direction of the relative heading angle is superimposed on the vehicle body set in the quadrangular shape as described above, and then a cross-sectional area of the superimposed portion is identified so that a value of the identified cross-sectional area may be determined as the predicted area of collision.

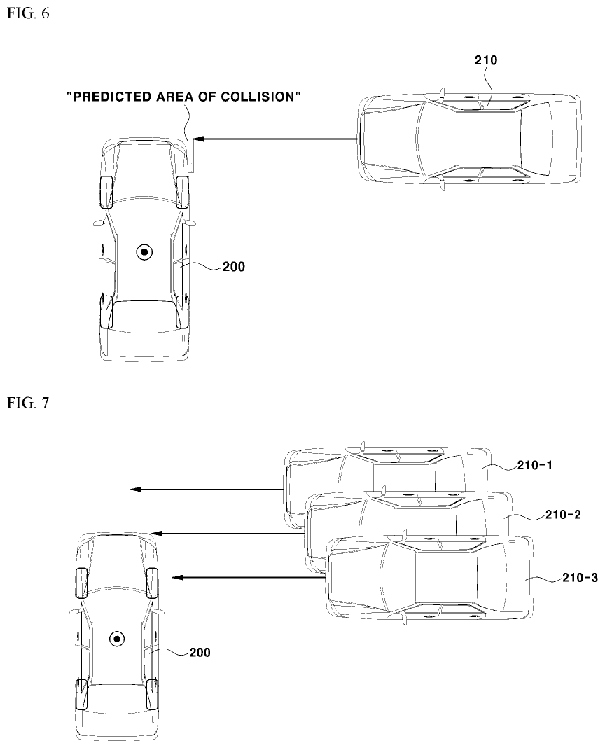

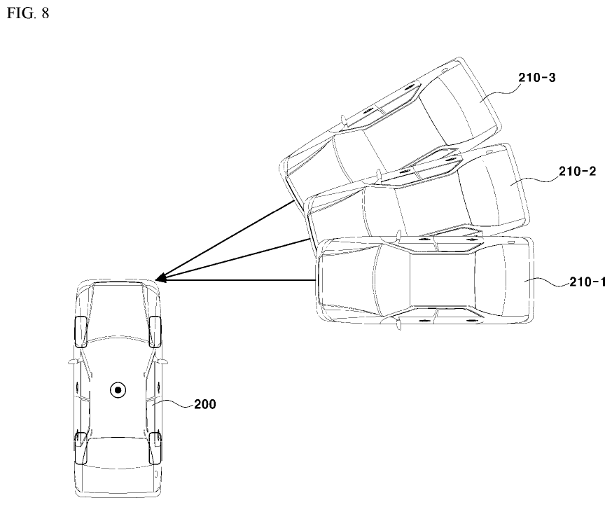

Referring to FIG. 6, when the heading angle of other vehicle 210 is perpendicular to the heading angle of the vehicle 200, the predicted area of collision may be determined according to a superimposed area between a heading position of the vehicle 200 and a heading position of other vehicle 210.

As an exemplary embodiment of the present disclosure, as shown in FIG. 7, although a heading angle of a first other vehicle 210-1 is perpendicular to the heading angle of the vehicle 200, when the heading position of the vehicle 200 and the heading position of the first other vehicle 210-1 are not superimposed, the predicted area of collision and the collision index become zero.

As an exemplary embodiment of the present disclosure, as shown in FIG. 7, when heading angles of the second and third other vehicles 210-2 and 210-3 are differently superimposed with and perpendicular to the heading angle of the vehicle 200, a predicted area of collision of the second other vehicle 210-2 with respect to the vehicle 200 and a predicted area of collision of the third other vehicle 210-3 with respect to the vehicle 200 may be differently determined.

In the instant case, as shown in FIG. 7, when the distance between the vehicle 200 and the second other vehicle 210-2 is shorter than the distance between the vehicle 200 and the third other vehicle 210-3, a collision index representing a probability of collision of the second other vehicle 210-2 with respect to the vehicle 200 and a collision index representing a possibility of collision of the third other vehicle 210-3 with respect to the vehicle 200 may be differently determined.

Referring to FIG. 8, even when the heading angles of the first, second, and third other vehicles 210-1, 210-2, and 210-3 form different angles with respect to the heading angle of the vehicle 200, predicted areas of collision may be differently determined according to an area where the heading position of the vehicle 200 and the heading position of the other vehicles 210 are superimposed.

For example, as shown in FIG. 8, when approach collisions of the first, second, and third other vehicles 210-1, 210-2, and 210-3 are expected at a right corner of the vehicle 200, because the heading angles of the first, second, and third other vehicles 210-1, 210-2, and 210-3 are different from the heading angle of the vehicle 200, a predicted area of collision of the first other vehicle 210-2 with respect to the vehicle 200 may be determined to be the smallest, and a predicted area of collision of the third other vehicle 210-3 with respect to the vehicle 200 may be determined to be the largest.

When the distances between the vehicle 200 shown in FIG. 8 and the first, second, and third other vehicles 210-1, 210-2, and 210-3 are the same type of vehicle, and the vehicle speeds of the first, second, and third vehicles 210-1, 210-2, and 210-3 approaching the vehicle 200 are the same, because the predicted area of collision of the third other vehicle 210-3 is determined to be the largest, a collision index representing a probability of collision of the third other vehicle 210-3 may be determined to be the largest.

As described above, the collision index may be differently determined according to the vehicle speed of other vehicle, the distance between the vehicle and other vehicle, and the expected area of collision of other vehicle with respect to the vehicle, and this means that, as the determined collision index is high, the probability of collision of other vehicle with respect to the vehicle is high.

Next, the autonomous driving controller 100 compares the collision indexes of other vehicles determined as described above with a reference value.

First, the autonomous driving controller 100 compares a first reference value with the highest maximum collision index among the collision indexes of other vehicles, which are determined as described above (S112).

The reason for comparing the first reference value with the highest maximum collision index among the collision indexes of other vehicles is that the other vehicle having the maximum collision index includes the highest probability of collision, and power is applied in advance to control portions and actuating portions of the vehicle for turning the vehicle in a direction of collision avoidance with other vehicle to put the control portions and the actuating portions into a driving standby state.

In the instant case, the control portions for turning the vehicle in the direction of collision avoidance with other vehicle may be the braking controller 130 and the motor controller 140, and the actuating portions may be the braking system 132 and the IWM 142 which are mounted in each wheel.

As the comparison result in S112, when the maximum collision index is greater than the first reference value, power is applied in advance to the control portions and the actuating portions for turning the vehicle in the direction of collision avoidance with other vehicle (S113).

For example, according to a command of the autonomous driving controller 100, the power may be applied in advance to the motor controller 140 and the IWM 142, which are mounted in each wheel, to put the motor controller 140 and the IWM 142 into a driving standby state, and the power may be applied in advance to the braking controller 130 and the braking system 132 to put the braking controller 130 and the braking system 132 into a driving standby state.

Furthermore, the autonomous driving controller 100 compares a second reference value with the highest maximum collision index among the collision indexes of other vehicles, which are determined as described above (S114).

As the comparison result, when the maximum collision index is greater than the second reference value, the autonomous driving controller 100 is configured to control the vehicle in the direction of collision avoidance with other vehicle (S115).

That is, according to the command of the autonomous driving controller 100, the vehicle may be turned in the direction of collision avoidance with other vehicle due to a driving torque of the IWM motor 142 under the control of the motor controller 140 and a braking torque of the braking device 132 under the control of the braking controller 130.

Here, a method of controlling the vehicle in the direction of collision avoidance with other vehicle will be described in detail.

First, a direction of collision avoidance of the vehicle is determined to control the vehicle in the direction of collision avoidance with other vehicle (S115-1).

To the present end, the autonomous driving controller 100 may be configured to determine a direction of collision avoidance which is a rotation direction generated due to a collision of the vehicle with other vehicle using the heading angle and position of other vehicle with respect to the heading angle and position of the vehicle, and the expected area of collision of other vehicle with respect to the vehicle.

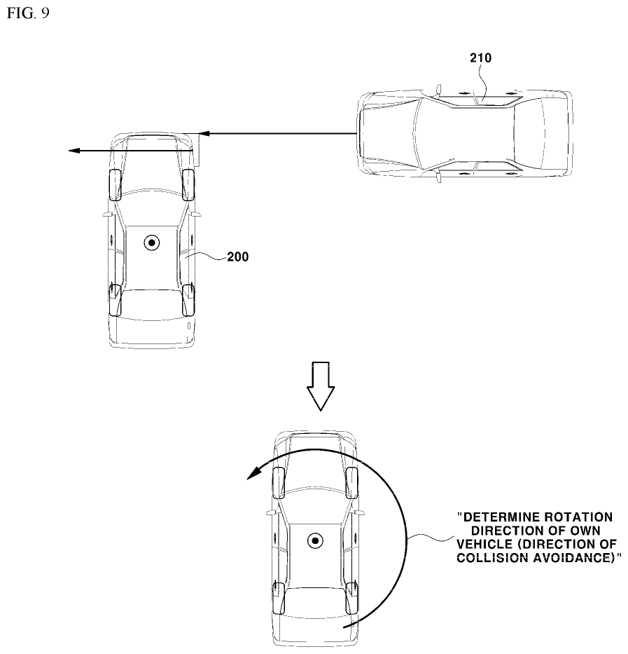

For example, as shown in FIG. 9, when other vehicle 210 moves to the vehicle 200 from the right side and a collision with a front right side of the vehicle 200 is predicted, because the vehicle 200 may be rotated in a counterclockwise direction upon collision, the direction of collision avoidance of the vehicle 200 may be determined as a counterclockwise direction thereof.

Subsequently, a rotation center of the vehicle for turning the vehicle in the direction of collision avoidance is determined (S115-2).

To the present end, the autonomous driving controller 100 may be configured to determine the rotation center of the vehicle for turning the vehicle in the direction of collision avoidance to the center of gravity of the vehicle or one selected among the wheels of the vehicle using the heading angle and position of other vehicle with respect to the heading angle and position of the vehicle, and the expected area of collision of other vehicle with respect to the vehicle.

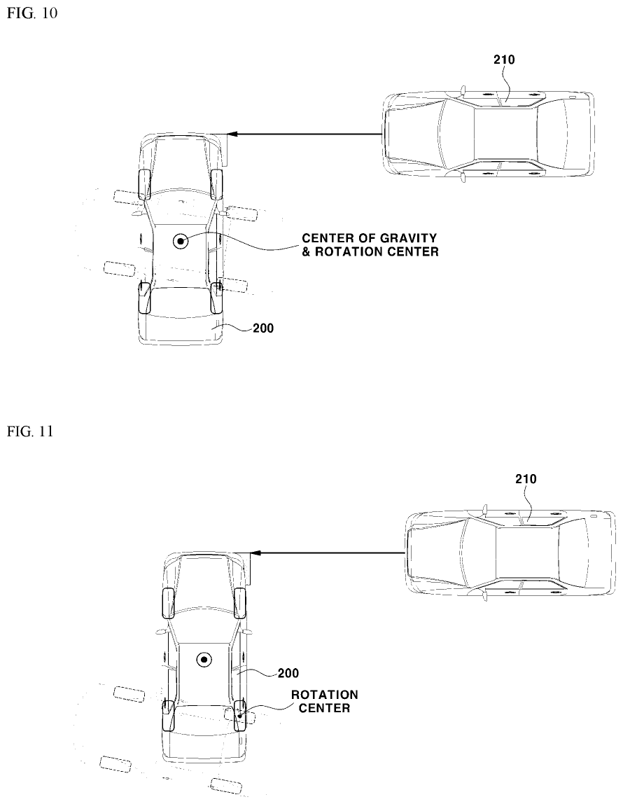

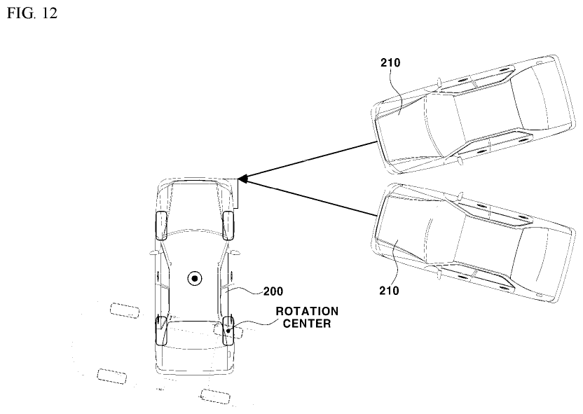

For example, as shown in FIG. 10, when other vehicle 210 moves to the vehicle 200 from the right side and a collision with the front right side of the vehicle 200 (e.g., the right side of a bumper) is predicted, because a predicted area of collision of other vehicle with respect to the vehicle is small, and thus collision avoidance is possible even when the vehicle is rotated based on a position similar to the center of gravity so that the rotation center of the vehicle for turning the vehicle in the direction of collision avoidance may be determined as the center of gravity of the vehicle.

Alternatively, as shown in FIG. 11, when other vehicle 210 moves to the vehicle 200 from the right side and a collision with the front right side of the vehicle 200 (e.g., the bumper and a right side of a front wheel) is predicted, because the predicted area of collision of other vehicle with respect to the vehicle is large, and thus collision avoidance is impossible even when the vehicle is rotated based on the center of gravity so that the rotation center of the vehicle for turning the vehicle in the direction of collision avoidance may be determined as a rear right wheel of the vehicle.

Alternatively, as shown in FIG. 12, when other vehicle 210 moves to the vehicle 200 diagonally with respect to the longitudinal axis of the vehicle 200 from the right side and a collision with the front right side of the vehicle 200 is predicted, the rotation center of the vehicle for turning the vehicle in the direction of collision avoidance may be determined as the rear right wheel of the vehicle.

Alternatively, as shown in FIG. 13, when other vehicle 210 diagonally moves to the vehicle 200 from the front side and a collision with a left corner of the front side of the vehicle 200 is predicted, the rotation center of the vehicle for turning the vehicle in the direction of collision avoidance may be determined as a front right wheel of the vehicle.

Alternatively, as shown in FIG. 14, when other vehicle 210 diagonally moves to the vehicle 200 from the front side and a collision with a front left side of the vehicle 200 is predicted, because the predicted area of collision of other vehicle with respect to the vehicle is large, and thus collision avoidance is impossible even when the vehicle is rotated based on the front right wheel so that the rotation center of the vehicle for turning the vehicle in the direction of collision avoidance may be determined as the rear right wheel of the vehicle.

As described above, by considering the heading angle and position of other vehicle with respect to the heading angle and position of the vehicle, and the expected area of collision of other vehicle with respect to the vehicle, the rotation center of the vehicle for turning the vehicle in the direction of collision avoidance may be determined as the center of gravity of the vehicle or one selected among the wheels of the vehicle.

Thus, according to the command of the autonomous driving controller 100, the motor controller 140 applies a driving torque to one or more selected from the IWMs 142 mounted in the wheels of the vehicle 200, and the braking controller 130 applies a braking torque to one or more selected from the brake systems 132 mounted in the wheels. Thus, the vehicle 200 may be rotated in the direction of collision avoidance based on the center of gravity of the vehicle or one selected from the wheels of the vehicle.

Accordingly, a target rotation angle of the vehicle 200 for turning the vehicle in the direction of collision avoidance is determined (S115-3).

That is, when the vehicle is rotated in the direction of collision avoidance, the vehicle is rotated to an angle at which collision avoidance with other vehicle is possible without being indefinitely rotated. Thus, the target rotation angle of the vehicle for turning the vehicle in the direction of collision avoidance is determined.

To the present end, the autonomous driving controller 100 may determine, as the target rotation angle of the vehicle, an angle at which the vehicle may be rotated to a position as away from other vehicle as possible by considering the heading angle and position of other vehicle with respect to the heading angle and position of the vehicle, and the expected area of collision of other vehicle with respect to the vehicle.

In the instant case, the position as away from other vehicle as possible may be a position where the vehicle is disposed parallel to or perpendicular to other vehicle.

Accordingly, according to the heading angle and the position of other vehicle with respect to the heading angle and the position of the vehicle, which are detectable by the detection portion for the autonomous driving, and the predicted area of collision of other vehicle with respect to the vehicle, the target rotation angle of the vehicle may be determined as an angle at which the vehicle may be rotated to a position which is the position as away from other vehicle as possible and where the vehicle is disposed parallel to or perpendicular to other vehicle.

The target rotation angle of the vehicle may be determined as an angle at which the vehicle is rotated to a position where the vehicle is disposed parallel to the heading angle of other vehicle. The reason is that a risk of collision with other vehicle is the smallest when the vehicle is rotated to a position parallel to the heading angle of other vehicle for collision avoidance.

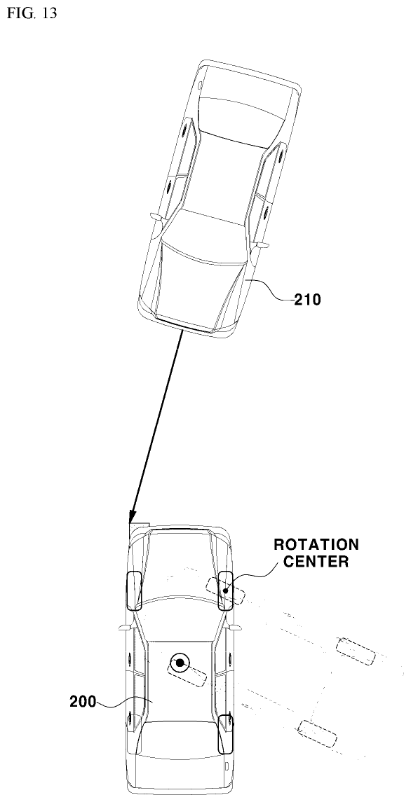

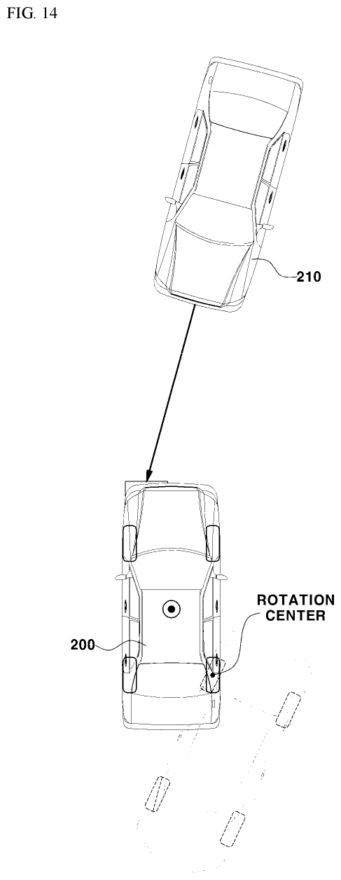

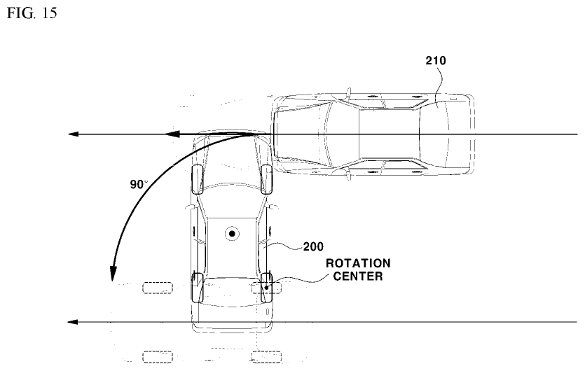

For example, as shown in FIG. 15, when other vehicle 210 moves to the vehicle 200 from the right side, a collision with the front right side of the vehicle 200 is predicted, and the direction of collision avoidance of the vehicle is determined in the counterclockwise direction, the target rotation angle of the vehicle may be determined as 90 degrees to allow the vehicle to be rotated to a position disposed parallel to other vehicle.

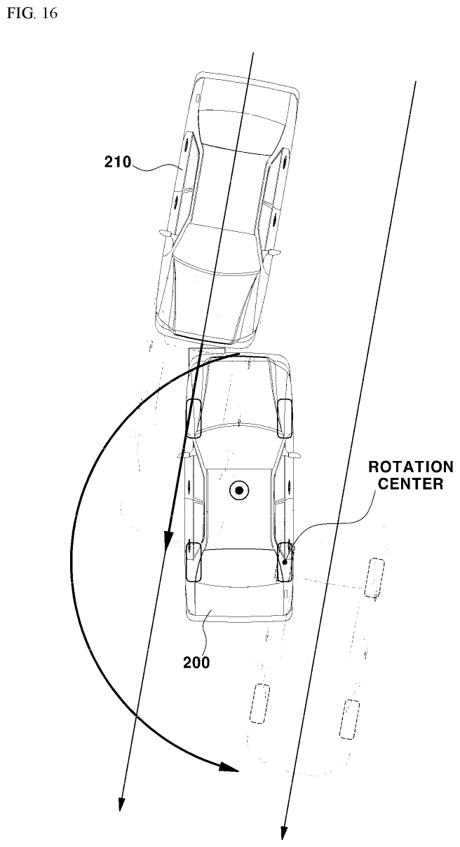

Alternatively, as shown in FIG. 16, when other vehicle 210 diagonally moves to the vehicle 200 from the front side, a collision with the front left side of the vehicle 200 is predicted, and the direction of collision avoidance of the vehicle is determined in the counterclockwise direction, the target rotation angle of the vehicle may be determined as 160 degrees to allow the vehicle to be rotated to a position disposed parallel to other vehicle.

On the other hand, when the vehicle is rotated in the direction of collision avoidance, because the vehicle cannot immediately stop at the position of the target rotation angle due to the rotational inertia of the vehicle, a stop time point of the driving torque and an increase time point of the braking torque for each wheel of the vehicle to immediately stop the rotation of the vehicle are required. In the instant case, a response speed of the driving torque may be different from a response speed of the braking torque due to characteristics of the driving system and the braking system of the vehicle.

For example, when the driving system is a motor and the braking system is a hydraulic braking system, because a response speed of the motor may be fast and a response speed of the hydraulic braking system may be slow, the stop time point of the driving torque is determined by considering responsiveness of the driving system, and the increase time point of the braking torque is determined by considering responsiveness of the hydraulic braking system.

Subsequently, a steering angle of the vehicle may be determined to rapidly turn the vehicle in the direction of collision avoidance (S115-4).

That is, when the vehicle is rotated in the direction of collision avoidance, the vehicle is rapidly rotated to an angle at which collision avoidance with other vehicle is possible. Thus, a steering angle of the vehicle for rapidly turning the vehicle in the direction of collision avoidance is determined.

To the present end, the autonomous driving controller 100 may be configured to determine a steering angle in a direction opposite to the direction of collision avoidance of the vehicle determined in S115-1 and for rapidly turning to the target rotation angle of the vehicle determined in S115-3.

Thus, according to a command of the steering angle determined by the autonomous driving controller 100, steering of a front wheel or a rear wheel may be performed for rapidly turning the vehicle to the target rotation angle of the vehicle determined in S115-3 in the direction opposite to the direction of collision avoidance of the vehicle determined in S115-1 under the control of the steering controller 120.

In the instant case, when a steering angle of the front wheel is used to rapidly turn the vehicle in the direction of collision avoidance, a length of the moment arm becomes longer so that a greater rotational torque may be obtained.

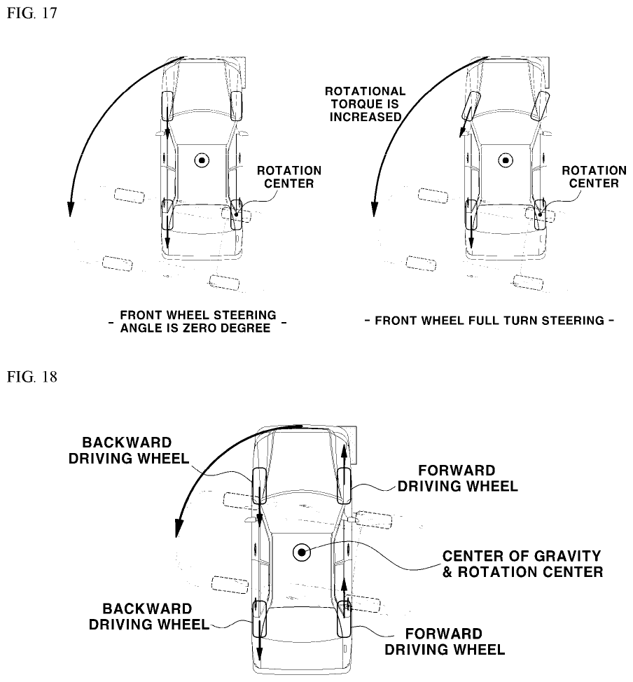

For example, as shown in FIG. 17, when a front wheel steering angle is fully turned and steered to be maximum in a direction opposite to the direction of collision avoidance (a target rotation direction) compared to a case in which the front wheel steering angle is zero degree, because it is possible to generate a larger rotational torque with respect to the vehicle in the direction of collision avoidance, the vehicle may be more rapidly turned in the direction of collision avoidance.

Of course, when backward driving is required in the direction of collision avoidance (the target rotation direction) of the vehicle, a steering direction of the front wheel may be determined in the direction opposite to the direction of collision avoidance (the target rotation direction), and when forward driving is required, the steering direction of the front wheel may be determined in the same direction as the direction of collision avoidance (the target rotation direction).

Next, to actually rotate and drive the vehicle in the direction of collision avoidance, a driving wheel and a braking wheel are selected among the wheels, and a forward or backward driving direction of the selected driving wheel is determined (S115-5).

After the direction of collision avoidance (the target rotation direction), the rotation angle (the target rotation angle), and the steering angle of the vehicle are determined, to rotate the vehicle in the direction of collision avoidance, the autonomous driving controller 100 selects the driving wheel and the braking wheel among the wheels and is configured to determine a forward or backward driving direction of the selected driving wheel.

For example, as shown in FIG. 18, when the rotation center of the vehicle is determined as the center of gravity of the vehicle and the direction of collision avoidance of the vehicle is determined as the counterclockwise direction, all the wheels may be selected as driving wheels, and the front and rear right wheels may be determined as forward driving wheels, and the front and rear left wheels may be determined as backward driving wheels.

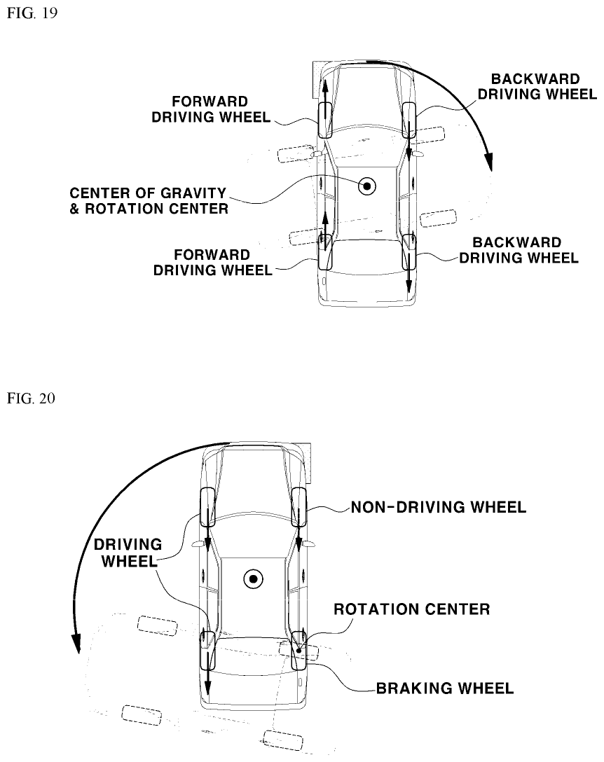

Alternatively, as shown in FIG. 19, when the rotation center of the vehicle is determined as the center of gravity of the vehicle and the direction of collision avoidance of the vehicle is determined as the clockwise direction, all the wheels may be selected as driving wheels, and the front and rear right wheels may be determined as rearward driving wheels, and the front and rear left wheels may be determined as forward driving wheels.

On the other hand, when the rotation center of the vehicle is determined as a specific wheel among the wheels of the vehicle, the specific wheel may be selected as the braking wheel, and two or more wheels, excluding the braking wheel, may be selected as driving wheels.

For example, as shown in FIG. 20, when the rotation center of the vehicle is determined as the rear right wheel of the vehicle, the rear right wheel may be selected as the braking wheel, and the front left wheel and the rear left wheel are selected as the driving wheels and determined as the backward driving wheels and the front right wheel may be determined as a non-driving wheel.

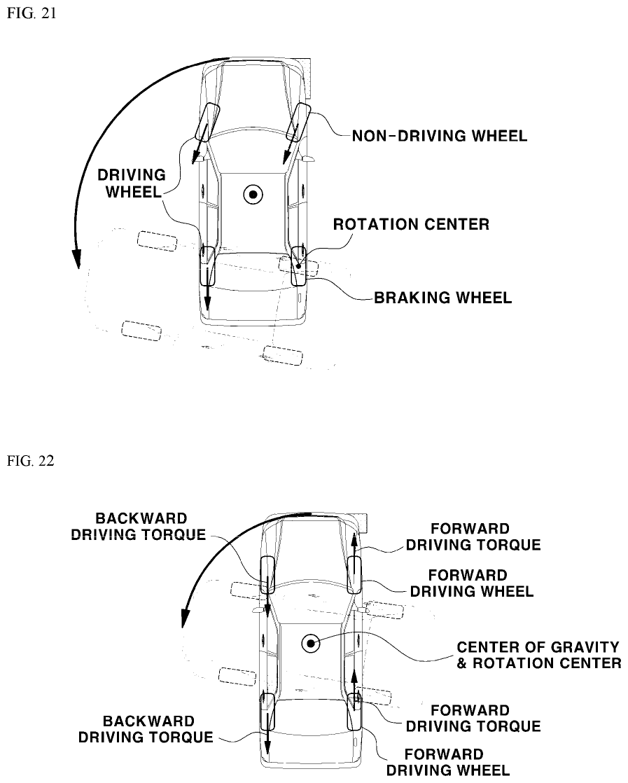

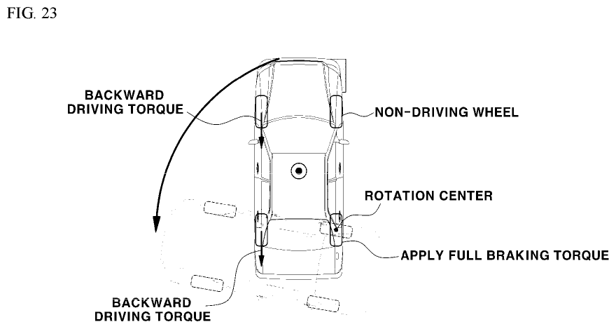

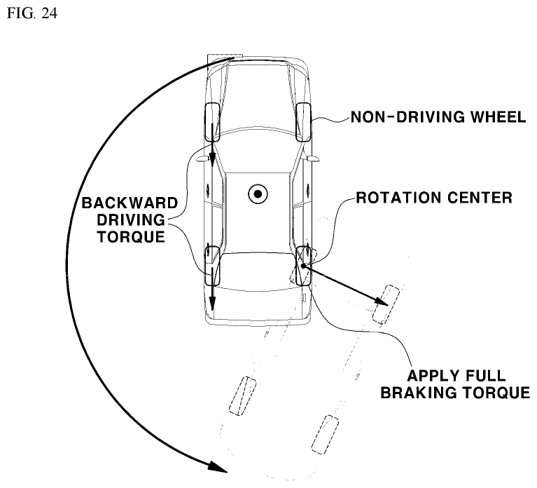

Alternatively, as shown in FIG. 21, even when the rotation center of the vehicle is determined as the rear right wheel of the vehicle and the front wheel steering is performed in the direction opposite to the direction of collision avoidance of the vehicle, the rear right wheel may be selected as the braking wheel, and the front left wheel and the rear left wheel are selected as the driving wheels and determined as the backward driving wheels and the front right wheel may be determined as the non-driving wheel.

In the instant case, the reason for determining the front right wheel as the non-driving wheel instead of the driving wheel is that the driving direction is toward the rotation center (the rear right wheel) when the front right wheel is driven so that a translational motion of the vehicle may occur to hinder the rotation in the direction of collision avoidance of the vehicle.

Next, control is performed to apply the braking torque to the braking wheel and apply the driving torque to the driving wheel (S115-6).

To the present end, under the control of the braking controller 130 according to the command of the autonomous driving controller 100, a braking hydraulic pressure is supplied to the hydraulic braking system 132 mounted in the braking wheel so that a full braking torque may be applied to the braking wheel, and under the control of the motor controller 140 according to the command of the autonomous driving controller 100, the IWM 142 mounted in the driving wheel is driven so that the driving torque may be applied to the driving wheel.

Therefore, the braking torque is applied to the braking wheel and the driving torque is applied to the driving wheel, and thus the vehicle is rotated in the direction of collision avoidance up to the determined target rotation angle. Thus, it is possible to easily prevent a collision accident and damage due to other vehicle during parking or stopping.

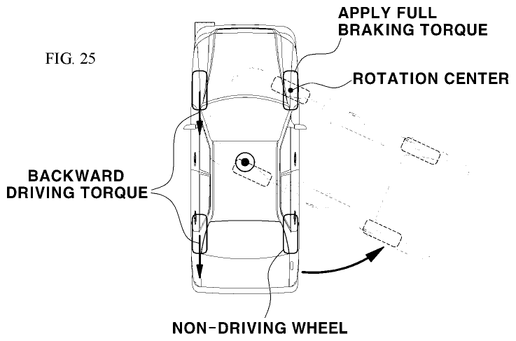

For example, as shown in FIG. 22, when the rotation center of the vehicle is determined as the center of gravity, because a backward driving torque is applied to the front left wheel and rear left wheel, and simultaneously, a forward driving torque is applied to the front right wheel and the rear right wheel, the vehicle may be rotated as much as the target rotation angle in the direction of collision avoidance (the counterclockwise direction) so that it is possible to easily prevent a collision accident and damage due to other vehicle during parking or stopping.

Alternatively, as shown in FIGS. 23 and 24, when the rotation center of the vehicle is determined as the rear right wheel, because a full braking torque is applied to the rear right wheel and the backward driving torque is applied to the front left wheel and the rear left wheel, the vehicle may be rotated as much as the target rotation angle in the direction of collision avoidance (the counterclockwise direction) so that it is possible to easily prevent a collision accident and damage due to other vehicle during parking or stopping.

Alternatively, as shown in FIG. 25, when the rotation center of the vehicle is determined as the front right wheel, because the full braking torque is applied to the front right wheel and the backward driving torque is applied to the front left wheel and the rear left wheel, the vehicle may be rotated as much as the target rotation angle in the direction of collision avoidance (the counterclockwise direction) so that it is possible to easily prevent a collision accident and damage due to other vehicle during parking or stopping.

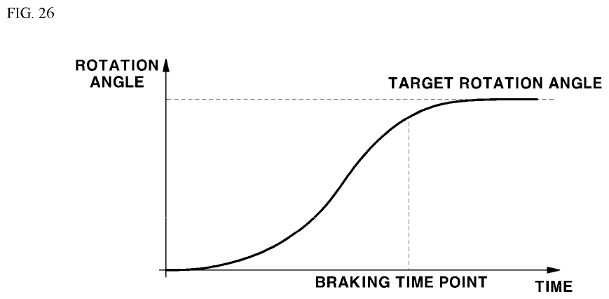

Meanwhile, because the control for applying the braking torque to the braking wheel and the driving torque to the driving wheel is performed, even when the vehicle is immediately rotated in the direction of collision avoidance, as shown in a graph of FIG. 26, a delay phenomenon may initially occur due to inertia of the vehicle.

Thus, to minimize the delay phenomenon at an initial stage when the vehicle starts to be rotated in the direction of collision avoidance, it is preferable, at a rotation start time point, to control the steering angle to be fully turned and to maximally apply the driving torque to the driving wheel.

Furthermore, considering that the vehicle cannot be accurately stopped at the target rotation angle due to the inertia of the vehicle, braking should be performed in advance before the vehicle reaches the target rotation angle for the vehicle to be accurately stopped at the target rotation angle.

When braking is not performed in advance until the vehicle is rotated to the target rotation angle for collision avoidance or braking is performed at the target rotation angle, the vehicle may be rotated beyond the target rotation angle, and thus a subsequent accident may occur.

To the present end, control is required to accurately stop the vehicle at the target rotation angle after the vehicle is rotated only to the target rotation angle for collision avoidance.

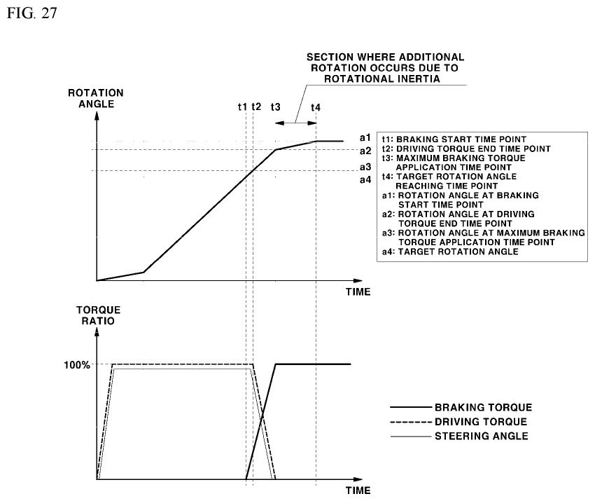

FIG. 27 shows a control example in which, when the rotation center of the vehicle is determined as the center of gravity, the vehicle is accurately stopped at the target rotation angle after being rotated only to the target rotation angle.

For the control of accurately stopping the vehicle at the target rotation angle after the vehicle is rotated only to the target rotation angle for collision avoidance, as shown in FIG. 27, a braking start time point t1 at which braking of the vehicle starts in advance before reaching the target rotation angle using rotational inertia information of the vehicle, vehicle rotation information, a driving torque, and a braking torque, a driving torque end time point t2 at which the driving torque becomes zero before reaching the target rotation angle, a maximum braking torque application time point t3 at which a maximum braking torque is applied to stop the vehicle when the vehicle reaches the target rotation angle, and a target rotation angle reaching time point t4 at which the vehicle is stopped at the target rotation angle may be set in advance.

Furthermore, because the braking start time point t1, the driving torque end time point t2, the maximum braking torque application time point t3, and the target rotation angle reaching time point t4 are set in advance, when the vehicle is rotated to a target rotation angle a4 for collision avoidance, a rotation angle a1 at the braking start time point t1, a rotation angle a2 at the driving torque end time point t2, and a rotation angle a3 at the maximum braking torque application time point t3 may be determined.

Thus, at a time point at which the vehicle starts to be rotated in the direction of collision avoidance, the steering controller 120 according to the command of the autonomous driving controller 100 is configured to control the steering angle to be maximally fully turned, and the driving torque of the driving wheel is also maximized according to driving of IWM 142 under the control of the motor controller 140 so that a delay may be minimized at an initial stage when the vehicle starts to be rotate in the direction of collision avoidance.

In the instant case, when the backward driving is required in the direction of collision avoidance (the target rotation direction) of the vehicle, a steering angle of the front wheel may be full-turn controlled to be maximum in the direction opposite to the direction of collision avoidance (the target rotation direction), and when the forward driving is required, the steering angle of the front wheel may be full-turn controlled to be maximum in the same direction as the direction of collision avoidance (the target rotation direction).

Subsequently, when the vehicle is rotated in the direction of collision avoidance to reach the braking start time point t1, the braking torque is primarily applied to each wheel in advance according to an operation of the braking system 132 under the control of the braking controller 130. This is because the braking torque cannot rise to a maximum torque at once.

Thus, when the vehicle is rotated in the direction of collision avoidance to reach the braking start time point t1, the braking torque may be primarily applied in advance to a wheel which is the rotation center to allow the vehicle to be accurately stopped at the target rotation angle (S115-7).

Subsequently, when the vehicle is rotated in the direction of collision avoidance to reach the driving torque end time point t2, the driving torque applied to the driving wheel is controlled to zero to allow the vehicle to be accurately stopped at the target rotation angle (S115-8).

In the instant case, when the vehicle is rotated in the direction of collision avoidance, even though the braking torque is primarily applied to a wheel which is the rotation center at the braking start time point t1 and the driving torque is controlled to zero at the driving torque end time point t2, an additional rotation may occur due to the rotational inertia of the vehicle.

Thus, when the vehicle is rotated in the direction of collision avoidance and reaches the maximum braking torque application time point t3, the maximum braking torque is applied to all the wheels until the target rotation angle reaching time point t4 (S115-9).

Therefore, the vehicle may be stopped after being rotated as much as the target rotation angle in the direction of collision avoidance so that it is possible to easily prevent a collision accident and damage due to other vehicle during parking or stopping, and a subsequent accident which occurs due to the vehicle being rotated beyond the target rotation angle may be prevented.

When the vehicle accident prevention control during parking or stopping is terminated, an operation of notifying the driver may be further performed (S115-10).

For example, the autonomous driving controller 100 may transmit information indicating that the accident prevention control of the vehicle during parking or stopping is terminated to the smart device 113 possessed by the driver.

When the autonomous driving controller 100 transmits the information that the accident prevention control of the vehicle owned by the driver during parking or stopping s terminated to the smart device 113 possessed by the driver, contents asking whether to keep the vehicle rotated in the direction of collision avoidance or rotate the vehicle back to an original parking position may be further transmitted.

Thus, when the driver transmits a request for returning the vehicle to the original parking position to the autonomous driving controller through the dedicated app of the smart device 113, the vehicle may be returned to the original position through the autonomous driving control of the autonomous driving controller.

The present disclosure provides the following effects through the above-described problem solving means.

First, when a collision is expected when other vehicle approaches other parked or stopped vehicle in a state in which a vehicle is parked or stopped in a space such as a parking lot or shoulder, the vehicle wakes up on its own and automatically turns in a direction of collision avoidance using a driving torque and a braking torque so that it is possible to prevent a collision accident and damage due to other vehicle in a parked or stopped state of the vehicle and to protect the vehicle in the parked or stopped state.

Second, when the vehicle is rotated in the direction of collision avoidance, it is possible to prevent a subsequent accident from occurring when the vehicle is rotated exceeding a target rotation angle due to inertia by allowing the vehicle to be rotated up to a target rotation angle configured for collision avoidance.

Third, a driver is notified that the vehicle is rotated in the direction of collision avoidance with other vehicle through accident prevention control during parking or stopping, providing convenience for the driver to recognize a current state of the parked or stopped vehicle owned by the driver from a long distance.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the exemplary embodiment of the present disclosure, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

A singular expression includes a plural expression unless the context clearly indicates otherwise.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of controlling collision avoidance of a vehicle, the method comprising:
monitoring, by an detection portion for autonomous driving of the vehicle, information on other vehicle, which is approachable to the vehicle, and an object in a parked or stopped state after a starting of the vehicle is turned off;
determining, by an autonomous driving controller, whether the other vehicle moves based on the monitored information of the detection portion for the autonomous driving;
when the autonomous driving controller concludes that the other vehicle moves, determining, by the autonomous driving controller, a collision index representing a probability of collision of the other vehicle with the vehicle; and
comparing the collision index with a reference value, and when the collision index is greater than the reference value, controlling, by the autonomous driving controller, the vehicle in a direction of the collision avoidance with the other vehicle.

2. The method of claim 1, further including:
before the starting of the vehicle is turned off, checking, by the detection portion for the autonomous driving, the information on the other vehicles and the object present around the vehicle.

3. The method of claim 1, further including:
before the starting of the vehicle is turned off, determining, by the autonomous driving controller, whether accident prevention control of the vehicle during parking or stopping of the vehicle is activated.

4. The method of claim 3, wherein, when the activation of the accident prevention control during the parking or the stopping is selected through an operating switch, a cluster for audio, video, navigation (AVN), or one input device among a display, a voice input device, and a smart device, the autonomous driving controller is configured to determine that the activation of the accident prevention control during the parking or the stopping is performed.

5. The method of claim 1, wherein, when the detection portion for the autonomous driving monitors the information on the other vehicle, which is approachable to the vehicle, and the object, the monitoring is performed at a low speed sampling for preventing battery discharging of the vehicle.

6. The method of claim 1, further including:
when the detection portion for the autonomous driving monitors the information on the other vehicle, which is approachable to the vehicle, and the object, notifying a driver of the vehicle when a state of charge (SOC) value of a battery in the vehicle is less than a reference value and terminating an accident prevention control during parking or stopping of the vehicle to prevent battery discharging of the vehicle.

7. The method of claim 1, wherein, in the determining, by the autonomous driving controller, whether the other vehicle moves, when the autonomous driving controller concludes that the movement of the other vehicle approachable to the vehicle is detected, the detection portion for the autonomous driving monitors the movement of the other vehicle at a high speed sampling.

8. The method of claim 1, wherein the collision index is determined by multiplying a vehicle speed of the other vehicle approaching the vehicle, a distance between the vehicle and the other vehicle, and a predicted area of collision of the other vehicle with the vehicle.

9. The method of claim 8, further including:
differently determining the predicted area of collision based on a vehicle body length in the vehicle, a vehicle body width in the vehicle, a vehicle body height in the vehicle, and a distance from a frontmost portion of the vehicle body to the center of gravity of the vehicle, a distance from the center of gravity of the vehicle to the other vehicle, and a relative heading angle of the vehicle with the other vehicle.

10. The method of claim 9, wherein the determining of the predicted area of collision includes:
setting, by the autonomous driving controller, the vehicle body in a quadrangular shape based on the center of gravity based on the vehicle body length, the vehicle body width, the vehicle body height, and the distance from the frontmost portion of the vehicle body to the center of gravity;
determining, by the autonomous driving controller, the distance from the center of gravity of the vehicle to the other vehicle and the relative heading angle with the other vehicle;
when the distance from the center of gravity of the vehicle to the other vehicle is within a predetermined distance, projecting, by the autonomous driving controller, the other vehicle onto the vehicle in a direction of the relative heading angle; and
superimposing the projected other vehicle with the vehicle body of the vehicle set in the quadrangular shape and determining a cross-sectional area of a superimposed portion between the vehicle and the other vehicle as the predicted area of collision.

11. The method of claim 1, wherein the comparing of the collision index with the reference value includes:
comparing a highest maximum collision index among collision indexes of other vehicles with a first reference value; and
comparing the highest maximum collision index among the collision indexes of the other vehicles with a second reference value.

12. The method of claim 11, wherein, when the maximum collision index is greater than the first reference value, power is applied in advance to control portions and actuating portions of the vehicle for turning the vehicle in the direction of collision avoidance with the other vehicle.

13. The method of claim 11, wherein, when the maximum collision index is greater than the second reference value, the controlling of the vehicle in the direction of collision avoidance with the other vehicle is performed by the autonomous driving controller.

14. The method of claim 1, wherein the controlling, by the autonomous driving controller, of the vehicle in the direction of collision avoidance with the other vehicle includes:
determining the direction of collision avoidance of the vehicle;
determining a rotation center of the vehicle for turning the vehicle in the direction of collision avoidance;
determining a target rotation angle of the vehicle;
determining a steering angle of the vehicle;
selecting a driving wheel and a braking wheel among wheels of the vehicle and determining a forward or backward driving direction of the selected driving wheel; and
applying a braking torque to the braking wheel and applying a driving torque to the driving wheel.

15. The method of claim 14, wherein the rotation center of the vehicle is determined as the center of gravity of the vehicle or one selected among the wheels of the vehicle according to a heading angle and a position of the other vehicle with respect to a heading angle and a position of the vehicle, and a predicted area of collision of the other vehicle with respect to the vehicle.

16. The method of claim 14, wherein the target rotation angle of the vehicle is determined as an angle at which the vehicle is rotated to a position which is the position as away from the other vehicle as possible and where the vehicle is disposed parallel to or perpendicular to the other vehicle according to the heading angle and the position of the other vehicle with respect to the heading angle and the position of the vehicle, and the predicted area of collision of the other vehicle with respect to the vehicle.

17. The method of claim 14, wherein the steering angle of the vehicle is determined as a maximum steering angle to turn the vehicle in the direction of collision avoidance.

18. The method of claim 14, wherein the controlling, by the autonomous driving controller, of the vehicle in the direction of collision avoidance with the other vehicle further includes controlling the vehicle to be stopped at the target rotation angle after the vehicle is rotated only to the target rotation angle for collision avoidance.

19. The method of claim 18, wherein the controlling of the vehicle to be stopped at the target rotation angle includes:
setting in advance a braking start time point (t1) at which braking of the vehicle starts in advance before reaching the target rotation angle, a driving torque end time point (t2) at which the driving torque becomes zero before reaching the target rotation angle, a maximum braking torque application time point (t3) at which a maximum braking torque is applied to stop the vehicle when the vehicle reaches the target rotation angle, and a target rotation angle reaching time point (t4) at which the vehicle is stopped at the target rotation angle;
when the vehicle is rotated in the direction of collision avoidance to reach the braking start time point (t1), applying the braking torque to each wheel of the vehicle in advance;
when the vehicle is rotated in the direction of collision avoidance to reach the driving torque end time point (t2), controlling the driving torque applied to the driving wheel to zero; and
when the vehicle is rotated in the direction of collision avoidance to reach the maximum braking torque application time point (t3), applying the maximum braking torque to all the wheels until the target rotation angle reaching time point (t4).

20. The method of claim 1, further including:
notifying termination of the accident prevention control of the vehicle during parking or stopping and a driver notification operation of asking whether to keep the vehicle rotated in the direction of collision avoidance or rotate the vehicle to return to an original parking position of the vehicle.
